(19) United States
(12) Patent Application Publication
(10) Pub. No.: US 2017/0345569 A1
(43) Pub. Date: Nov. 30, 2017

(54) MULTILAYER CERAMIC CAPACITOR

(71) Applicant: TAIYO YUDEN CO., LTD., Tokyo (JP)

(72) Inventors: Katsuo SAKATSUME, Takasaki-shi (JP); Masumi ISHII, Takasaki-shi (JP); Takeshi NOSAKI, Takasaki-shi (JP); Norihiro ARAI, Takasaki-shi (JP); Jyouji ARIGA, Takasaki-shi (JP)

(21) Appl. No.: 15/457,250

(22) Filed: Mar. 13, 2017

(30) Foreign Application Priority Data
May 31, 2016 (JP) 2016-109205

(51) Int. Cl. H01G 4/30; H01G 4/012; H01G 4/12; H01G 4/232

(52) U.S. Cl. CPC H01G 4/30; H01G 4/2325; H01G 4/012; H01G 4/1236

(57) ABSTRACT

A multilayer ceramic capacitor includes: a ceramic multilayer structure in which a ceramic dielectric layer and an internal electrode layer mainly composed of transition metal other than iron-group transition metal are alternately stacked, and a plurality of the internal electrode layers stacked are alternately exposed to a pair of end surfaces of the ceramic multilayer structure; a pair of external electrodes that are coupled to the internal electrode layer in the pair of end surfaces and are mainly composed of transition metal other than iron-group transition metal; and a conductor that is fixed to the ceramic multilayer structure, is located in a region other than a region in which the plurality of the internal electrode layers face each other, and is mainly composed of iron-group transition metal.

### CROSS-REFERENCE TO RELATED APPLICATION

This application is based upon and claims the benefit of priority of the prior Japanese Patent Application No. 2016-109205, filed on May 31, 2016, the entire contents of which are incorporated herein by reference.

### FIELD

A certain aspect of the present invention relates to a multilayer ceramic capacitor.

### BACKGROUND

Multilayer ceramic capacitors are structured to include a ceramic multilayer structure in which ceramic dielectric layers and internal electrode layers are alternately stacked, and external electrodes located on the surfaces of the ceramic multilayer structure and coupled to the internal electrode layers. For example, there have been known multilayer ceramic capacitors in which the external electrodes have a three-layer structure, the interlayer thereof is formed of a plating film made of Ni, Cu, or alloys made of them, and the average particle size of precipitate particles is made to be 0.005 μm or greater and 1 μm or less to improve reliability (for example, Japanese Patent Application Publication No. 2000-357627). There has also been known a technique that makes external electrodes have a multilayer structure including a first layer mainly composed of Ag and a second layer mainly composed of Cu and having a thickness of 4 μm or greater and makes the total thickness of the first and second layers be 5 μm or greater in a multilayer inductor to deal with higher frequency (for example, Japanese Patent Application Publication No. 2014-209590).

The multilayer ceramic capacitor undergoes a packaging process in which the multilayer ceramic capacitor is contained in a pocket formed in a tape made of paper or plastic to be provided in a final packaging form. The vibrations during the packaging process may cause the multilayer ceramic capacitor to fall out from the pocket or to rotate in the pocket. To reduce such troubles, it may be considered to use a magnet to inhibit the multilayer ceramic capacitor from falling out or rotating. However, when the internal electrode layer and the external electrode are mainly composed of transition metal other than iron-group transition metal to improve high-frequency characteristics, it is difficult to inhibit the multilayer ceramic capacitor from falling out or rotating with a magnet.

### SUMMARY OF THE INVENTION

According to an aspect of the present invention, there is provided a multilayer ceramic capacitor including: a ceramic multilayer structure in which a ceramic dielectric layer and an internal electrode layer mainly composed of transition metal other than iron-group transition metal are alternately stacked, and a plurality of the stacked internal electrode layers are alternately exposed to a pair of end surfaces of the ceramic multilayer structure; a pair of external electrodes that are coupled to the internal electrode layer in the pair of end surfaces and are mainly composed of transition metal other than iron-group transition metal; and a conductor that is fixed to the ceramic multilayer structure, is located in a region other than a region in which the plurality of the internal electrode layers face each other, and is mainly composed of iron-group transition metal.

### BRIEF DESCRIPTION OF THE DRAWINGS

FIG. 1A is a perspective view of a multilayer ceramic capacitor in accordance with a first embodiment, and FIG. 1B is a cross-sectional view taken along line A-A in FIG. 1A;

FIG. 2A is a perspective view of a sheet on which a pattern of internal electrode layers is printed, FIG. 2B is a perspective view of a sheet on which a pattern of dummy electrodes is printed, and FIG. 2C is a cross-sectional view illustrating a state where the sheets are stacked;

FIG. 3 illustrates a relationship between the weight of the multilayer ceramic capacitor and the weight of Ni;

FIG. 4A is a perspective view of a multilayer ceramic capacitor in accordance with a second embodiment, and FIG. 4B is a cross-sectional view taken along line A-A in FIG. 4A;

FIG. 5 is a perspective view of a sheet on which internal electrode layers and dummy electrodes are printed;

FIG. 6 is a cross-sectional view of a multilayer ceramic capacitor in accordance with a third embodiment;

FIG. 7 is a perspective view of a sheet on which dummy electrodes are printed; and

FIG. 8 is a cross-sectional view of a multilayer ceramic capacitor in accordance with a fourth embodiment.

### DETAILED DESCRIPTION

Hereinafter, a description will be given of embodiments of the present invention with reference to the accompanying drawings.

### First Embodiment

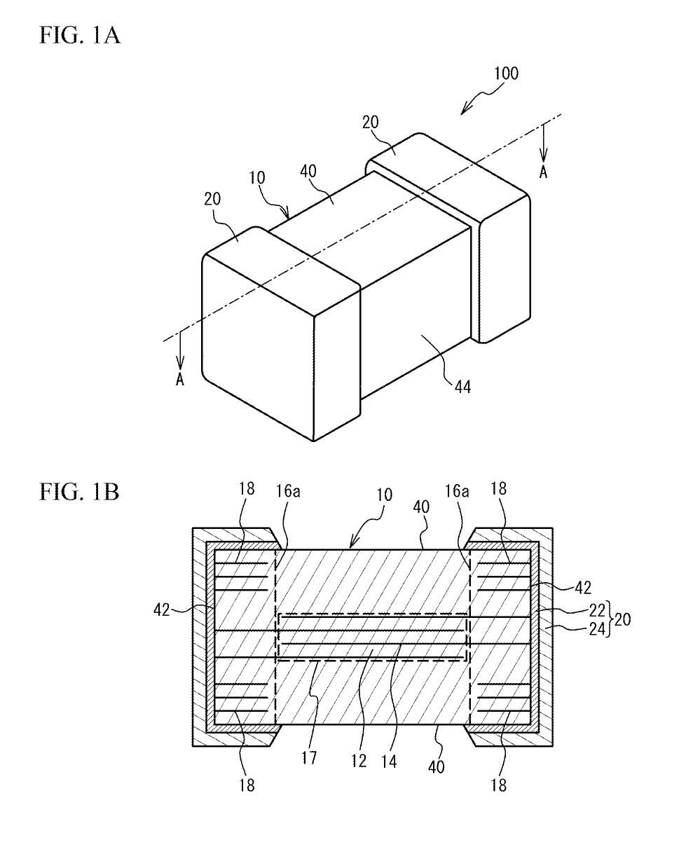

FIG. 1A is a perspective view of a multilayer ceramic capacitor 100 in accordance with a first embodiment, and FIG. 1B is a cross-sectional view taken along line A-A in FIG. 1A. As illustrated in FIG. 1A and FIG. 1B, the multilayer ceramic capacitor 100 of the first embodiment includes a ceramic multilayer structure 10 having a rectangular parallelepiped shape and a pair of external electrodes 20.

The ceramic multilayer structure 10 is formed of ceramic dielectric layers 12 and internal electrode layers 14 alternately stacked. A plurality of the stacked internal electrode layers 14 are alternately exposed to opposed surfaces of the ceramic multilayer structure 10. The external electrodes 20 are located on the surfaces, to which the internal electrode layers 14 are exposed, of the surfaces of the ceramic multilayer structure 10 and coupled to the internal electrode layers 14. Hereinafter, among the surfaces of the ceramic multilayer structure 10, the surfaces facing each other in the direction in which the ceramic dielectric layers 12 and the internal electrode layers 14 are stacked are referred to as principal surfaces 40, the surfaces intersecting with the principal surfaces 40 and to which the internal electrode layers 14 are exposed are referred to as end surfaces 42, and the surfaces intersecting with the principal surfaces 40 and the end surfaces 42 and to which the internal electrode layers 14 are not exposed are referred to as side surfaces 44.

Dummy electrodes 18 are fixedly located inside the ceramic multilayer structure 10. The dummy electrodes 18 are located in regions 16a and are located closer to the principal surfaces 40 than a plurality of the internal electrode layers 14, where the regions 16a are located between the internal electrode layers 14 exposed to one of a pair of the end surfaces 42 of the ceramic multilayer structure 10 and the other of the pair of the end surfaces 42, extends in the direction in which the ceramic dielectric layers 12 and the internal electrode layers 14 are stacked, and are located inside the ceramic multilayer structure 10. That is, the dummy electrodes 18 are located in regions other than a region 17 in which a plurality of the internal electrode layers 14 face each other.

The ceramic dielectric layers 12 are mainly composed of a ceramic material having a perovskite structure expressed by a general expression ABO₃. The perovskite structure includes ABO_{3-α} having an off-stoichiometric composition. For example, calcium zirconate (CaZrO₃) may be used as the ceramic material.

The internal electrode layers 14 are formed of a conductive thin film mainly composed of transition metal other than iron-group transition metal. The external electrode 20 includes a base electrode 22 that is in contact with the ceramic multilayer structure 10, and a plating film 24 that is in contact with the base electrode 22 and covers the base electrode 22. The base electrode 22 and the plating film 24 are mainly composed of transition metal other than iron-group transition metal. For example, the internal electrode layers 14 and the external electrodes 20 may be formed of a film mainly composed of Cu. Since the internal electrode layers 14 and the external electrodes 20 are mainly composed of transition metal other than iron-group transition metal, good high-frequency characteristics can be obtained.

The dummy electrodes 18 are formed of a conductive thin film mainly composed of iron-group transition metal. For example, the dummy electrodes 18 may be formed of a film mainly composed of Ni. Since the dummy electrodes 18 are located in the regions 16a inside the ceramic multilayer structure 10 so as to be located closer to the principal surfaces 40 than a plurality of the internal electrode layers 14, the formation of capacitance by the dummy electrodes 18 and the internal electrode layers 14 is inhibited even when the dummy electrodes 18 are coupled to the external electrodes 20. Therefore, even when the dummy electrodes 18 are mainly composed of iron-group transition metal, the effect on the high-frequency characteristics is reduced. In addition, even when the dummy electrodes 18 are coupled to the external electrodes 20, since the dummy electrodes 18 sandwiching the ceramic dielectric layers 12 have the same polarization, the formation of capacitance is inhibited.

A description will next be given of a manufacturing process of the multilayer ceramic capacitor 100. Initially, specified additive compounds are added to powder of the ceramic material mainly constituting the ceramic dielectric layer 12 according to the purpose. The examples of the additive compound include Mg, Mn, V, Cr, oxidation materials of rare-earth elements (Y, Dy, Tm, Ho, Tb, Yb, and Er), and oxidation materials of Sm, Eu, Gd, Co, Ni, Li, B, Na, K, and Si, or glass. For example, compounds containing additive compounds are mixed with powder of the ceramic material, and the resulting mixture is then calcined. Then, the resulting particles of the ceramic material are wet-blended with the additive compounds, dried, and ground to prepare the powder of the ceramic material.

Then, a binder such as polyvinyl butyral (PVB) resin, an organic solvent such as ethanol or toluene, and a plasticizer such as dioctyl phthalate (DOP) are added to the resulting powder of the ceramic material, and wet-blended. With use of the resulting slurry, a strip-shaped dielectric green sheet with a thickness of 0.8 μm or less is coated on a base material by, for example, a die coater method or a doctor blade method, and then dried.

Then, a conductive paste for forming the internal electrode layer 14 is printed on the surface of the dielectric green sheet by screen printing or gravure printing to form a sheet on which a pattern of the internal electrode layers 14 is printed. The conductive paste for forming the internal electrode layer 14 contains powder of the metal mainly constituting the internal electrode layer 14, a binder, a solvent, and other auxiliary agents as necessary. A conductive paste for forming the dummy electrode 18 is printed on the surface of the dielectric green sheet by screen printing or gravure printing to form a sheet on which a pattern of the dummy electrodes 18 is printed. The conductive paste for forming the dummy electrode contains powder of the metal mainly constituting the dummy electrode 18, a binder, a solvent, and other auxiliary agents as necessary. The binder and the solvent same as those contained in the conductive paste for forming the internal electrode layer 14 described above can be used. The ceramic material mainly constituting the ceramic dielectric layer 12 may be distributed as a co-material into the conductive paste for forming the internal electrode layer 14 and the conductive paste for forming the dummy electrode 18.

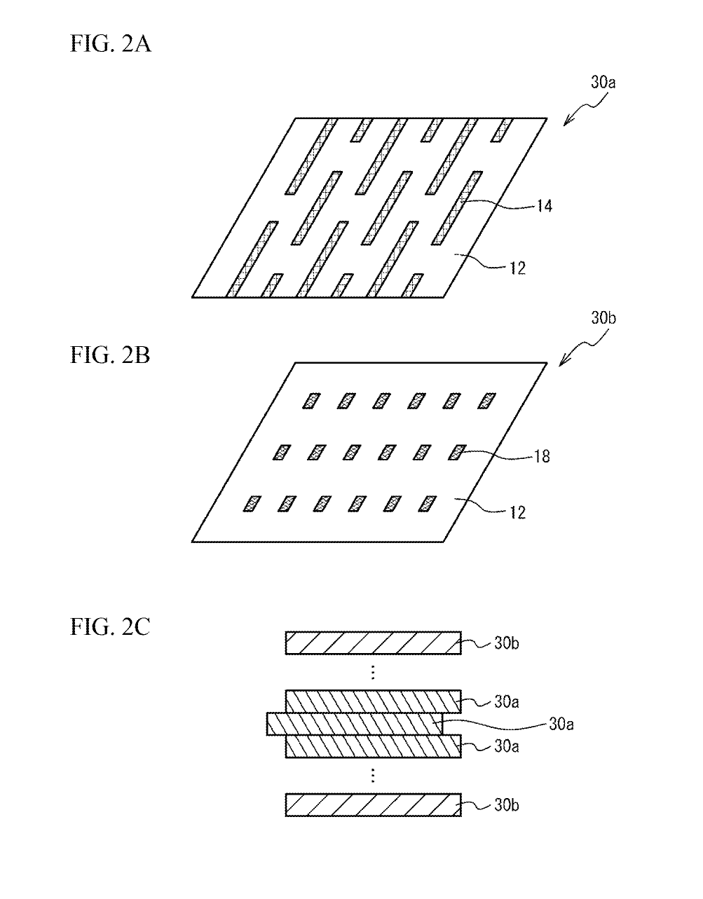

Then, the dielectric green sheet on which the pattern of the internal electrode layers 14 is printed is cut into a predetermined size. Similarly, the dielectric green sheet on which the pattern of the dummy electrodes 18 is printed is cut into a predetermined size. The sheets after cutting are illustrated in FIG. 2A and FIG. 2B. FIG. 2A is a perspective view of a sheet 30a on which a pattern of the internal electrode layers 14 is printed, and FIG. 2B is a perspective view of a sheet 30b on which a pattern of the dummy electrodes 18 is printed.

Then, with the base materials peeled, a predetermined number (for example, 10 to 40) of the sheets 30b, on which the pattern of the dummy electrodes 18 is printed, are stacked, a predetermined number (for example, 4 to 50) of the sheets 30a, on which the pattern of the internal electrode layers 14 is printed, are stacked on the top of the stacked sheets 30b, and a predetermined number (for example, 10 to 40) of the sheets 30b, on which the pattern of the dummy electrodes 18 is printed, are then stacked on the top of the stacked sheets 30a. All the sheets located on the top and bottom of the stacked sheets 30a do not need to be the sheets 30b on which the pattern of the dummy electrodes 18 is printed, and may include a dielectric sheet on which no electrode pattern is printed. FIG. 2C is a cross-sectional view illustrating a state where the sheets 30a and 30b are stacked. In FIG. 2C, the illustration of the internal electrode layers 14 and the dummy electrodes 18 is omitted. As illustrated in FIG. 2C, the dielectric sheets 30a are stacked so as to be alternately displaced from each other. Accordingly, the internal electrode layers 14 are stacked across the ceramic dielectric layers 12 so that the internal electrode layers 14 are alternately displaced from each other. In addition, when the sheets 30a and the sheets 30b are stacked, they are stacked so that the dummy electrode 18 overlaps with a part of the internal electrode layer 14.

Then, the stacked sheets 30a and 30b are bonded together and unite by applying a pressure to the stacked sheets 30a and 30b, and are then vertically and horizontally cut into small pieces by a cutting machine. At this time, the dielectric sheets 30a and 30b are cut so that the end edges of the internal electrode layers 14 are exposed to the both end faces in the length direction of the ceramic dielectric layers 12. The ceramic multilayer structure 10 having a rectangular parallelepiped shape is obtained through the above-described process.

Then, a conductive paste for forming the base electrodes 22 is coated on a pair of the end surfaces 42 to which the internal electrode layers 14 of the obtained ceramic multilayer structure 10 are exposed. A molded body is obtained through the above-described process. The conductive paste for forming the base electrodes 22 contains powder of the metal mainly constituting the base electrode 22, a binder, a solvent, and other auxiliary agents as necessary. The binder and the solvent same as those of the conductive paste for forming the internal electrode layer 14 described above can be used. In addition, for example, the ceramic material mainly constituting the ceramic dielectric layer 12 is distributed as a co-material into the conductive paste for forming the base electrodes 22. The content of the ceramic material in the conductive paste for forming the base electrodes 22 is made to be 5 weight % or less.

Then, the resulting molded body is calcined in a reducing atmosphere with, for example, H₂ of about 1.5 vol %, at approximately 950° C. for about two hours. This process allows the calcination of the ceramic dielectric layers 12 and the internal electrode layers 14 and the baking of the base electrodes 22 to be simultaneously performed.

Then, the plating films 24 are formed on the base electrodes 22 by electrolytic plating. The multilayer ceramic capacitor 100 is obtained through this process.

The multilayer ceramic capacitor undergoes a packaging process in which the multilayer ceramic capacitor is contained in a pocket formed in a tape made of paper or plastic to be provided in a final packaging form. The vibrations during the packaging process may cause the multilayer ceramic capacitor to fall out from the pocket or to rotate in the pocket. To reduce such troubles, it is considered to use a magnet to inhibit the multilayer ceramic capacitor from falling out or rotating. However, as described above, to make the high-frequency characteristics good, the internal electrode layers and the external electrodes are preferably mainly composed of transition metal (Cu or the like) other than iron-group transition metal. In this case, the internal electrode layers and the external electrodes are hardly drawn to a magnet. Thus, when the multilayer ceramic capacitor does not include any electrode other than the internal electrode layers and the external electrodes, it is difficult to inhibit the multilayer ceramic capacitor from falling out or rotating with a magnet.

In contrast, in the first embodiment, to obtain good high-frequency characteristics, the internal electrode layers 14 and the external electrodes 20 are mainly composed of transition metal (Cu) other than iron-group transition metal, but the dummy electrodes 18 (a conductor) mainly composed of iron-group transition metal (Ni) are additionally located in regions other than the region 17 in which a plurality of the internal electrode layers 14 face each other. Since the dummy electrodes 18 are drawn to a magnet, the position and attitude of the multilayer ceramic capacitor 100 can be controlled with a magnet. Therefore, while maintaining good high-frequency characteristics, the multilayer ceramic capacitor 100 can be inhibited from falling out from a pocket in a tape or rotating in a pocket, and the attitude of the multilayer ceramic capacitor 100 in the packaging process can be stabilized.

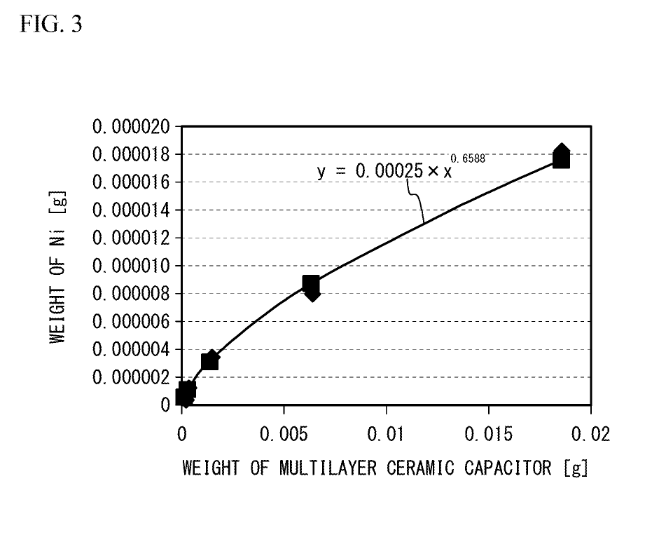

Here, examined was how much Ni is to weigh with respect to the weight of the multilayer ceramic capacitor 100 to stabilize the attitude when the dummy electrodes 18 contain Ni as iron-group transition metal. FIG. 3 illustrates a relationship between the weight of the multilayer ceramic capacitor 100 and the weight of Ni. FIG. 3 presents the weight of Ni that can stabilize the attitude when a magnetic flux density applied to the multilayer ceramic capacitor 100 is 10 gausses. In the formula in FIG. 3, y represents the weight of Ni, and x represents the weight of the multilayer ceramic capacitor. As illustrated in FIG. 3, the approximate curve of the weight of Ni with respect to the weight of the multilayer ceramic capacitor 100 that can stabilize the attitude of the multilayer ceramic capacitor 100 was (the weight of Ni)=0.00025×(the weight of the multilayer ceramic capacitor)^{0.6588}. Thus, this result reveals that when the magnetic flux density is approximately 10 gausses, the attitude can be stabilized by meeting the condition (the weight of Ni)≧0.00025×(the weight of the multilayer ceramic capacitor)^{0.6588}.

In addition, in the first embodiment, the dummy electrodes 18 are located inside the ceramic multilayer structure 10. Thus, the attitude of the multilayer ceramic capacitor 100 can be stabilized without changing the outer shape of the ceramic multilayer structure 10.

Moreover, in the first embodiment, the dummy electrodes 18 are located in the regions 16a inside the ceramic multilayer structure 10 and are located closer to the principal surfaces 40 than a plurality of the internal electrode layers 14. Thus, as described above, the formation of capacitance by the dummy electrodes 18 and the internal electrode layers 14 is inhibited, and the effect on high-frequency characteristics can be reduced even when the dummy electrodes 18 are mainly composed of iron-group transition metal.

The first embodiment has described an exemplary case where the dummy electrodes 18 are located near both the pair of the end surfaces 42 of the ceramic multilayer structure 10, but the dummy electrodes 18 may be located near one of the end surfaces 42. However, from a viewpoint of the stabilization of the attitude, the dummy electrodes 18 are preferably located near both the pair of the end surfaces 42 of the ceramic multilayer structure 10. In addition, the dummy electrodes 18 may be located near one of the opposed principal surfaces 40 of the ceramic multilayer structure 10. However, from a viewpoint of the stabilization of the attitude, the dummy electrodes 18 are preferably located near both the opposed principal surfaces 40.

The dummy electrodes 18 may be exposed to a pair of the end surfaces 42 of the ceramic multilayer structure 10, and may not be necessarily exposed to the pair of the end surfaces 42. When the dummy electrodes 18 are exposed to the end surface 42 of the ceramic multilayer structure 10, the dummy electrodes 18 may be in contact with the external electrode 20, or may not necessarily be in contact with the external electrode 20.

The first embodiment has described an exemplary case where the ceramic material contained in the ceramic dielectric layer 12 is calcium zirconate (CaZrO₃), but does not intend to suggest any limitation. The ceramic material contained in the ceramic dielectric layer 12 may be barium titanate (BaTiO₃), calcium titanate (CaTiO₃), strontium titanate (SrTiO₃), or Ba_{1-x-y}CaₓSr_{y}Ti_{1-z}Zr_{z}O₃ (0≦x≦1, 0≦y≦1, 0≦z≦1) having a perovskite structure.

The first embodiment has described an exemplary case where the internal electrode layers 14 and the external electrodes 20 are mainly composed of Cu, but the internal electrode layers 14 and the external electrodes 20 may be mainly composed of other transition metal other than iron-group transition metal. To make high-frequency characteristics good, the internal electrode layers 14 and the external electrodes 20 are preferably composed of transition metal other than iron-group transition metal, and preferably does not contain any iron-group transition metal. An exemplary case where the dummy electrodes 18 are mainly composed of Ni has been described, but the dummy electrodes 18 may be mainly composed of other iron-group transition metal (for example, Fe, Co). The dummy electrodes 18 are preferably composed of iron-group transition metal to stabilize the attitude with a magnet, and preferably does not contain any transition metal other than iron-group transition metal.

### Second Embodiment

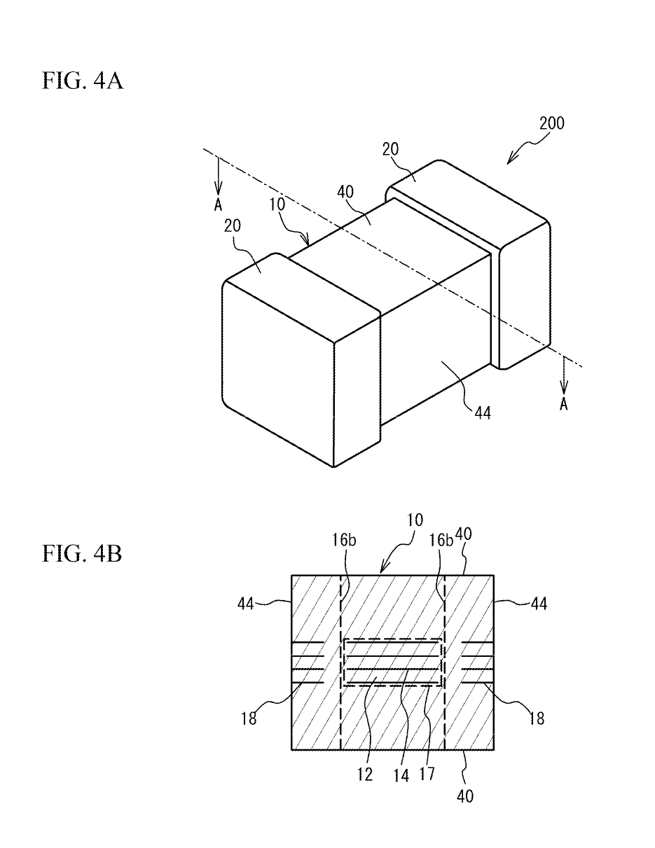

FIG. 4A is a perspective view of a multilayer ceramic capacitor 200 in accordance with a second embodiment, and FIG. 4B is a cross-sectional view taken along line A-A in FIG. 4A. As illustrated in FIG. 4A and FIG. 4B, in the multilayer ceramic capacitor 200 of the second embodiment, the dummy electrodes 18 are located in regions 16b that are located inside the ceramic multilayer structure 10, are other than the region 17, are located between the side surfaces 44 of the ceramic multilayer structure 10 and the internal electrode layers 14, and extend in the direction in which the ceramic dielectric layers 12 and the internal electrode layers 14 are stacked. The dummy electrode 18 and the internal electrode layer 14 are positioned in the same plane, for example. The dummy electrodes 18 may be exposed to the side surfaces 44 of the ceramic multilayer structure 10, or may not be necessarily exposed to the side surfaces 44 of the ceramic multilayer structure 10. Other structures are the same as those of the first embodiment, and thus the description thereof is omitted.

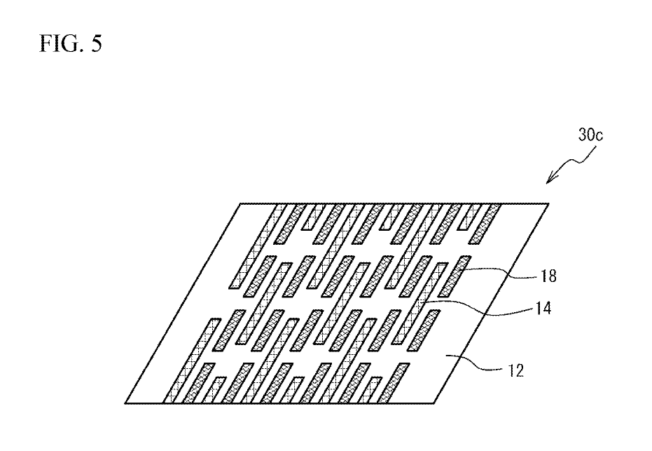

The multilayer ceramic capacitor 200 of the second embodiment can be manufactured by the same method as that of the first embodiment except that a sheet on which the internal electrode layers 14 and the dummy electrodes 18 are printed differs from the sheets of the first embodiment. FIG. 5 is a perspective view of a sheet 30c on which the internal electrode layers 14 and the dummy electrodes 18 are printed. The manufacturing method of the multilayer ceramic capacitor 200 of the second embodiment differs from that of the first embodiment in that a predetermined number (for example, 4 to 50) of the sheets 30c are stacked so as to be alternately displaced from each other, and dielectric sheets, on which no electrodes are printed, are then stacked on the top and bottom of the stacked sheets 30c.

In the second embodiment, the dummy electrodes 18 are located in the regions 16b inside the ceramic multilayer structure 10. Even in this case, the formation of capacitance by the dummy electrode 18 and the internal electrode layer 14 is inhibited. Therefore, the effect on high-frequency characteristics can be reduced and the attitude of the multilayer ceramic capacitor 200 can be stabilized.

Additionally, in the second embodiment, the dummy electrode 18 and the internal electrode layer 14 are positioned in the same plane. This structure allows the dummy electrodes 18 and the internal electrode layers 14 to be formed with use of a single sheet 30c as illustrated in FIG. 5. Therefore, the fabrication process can be simplified.

The second embodiment has described an exemplary case where the dummy electrodes 18 are located near both the opposed side surfaces 44 of the ceramic multilayer structure 10, but the dummy electrodes 18 may be only located near one of the side surfaces 44. However, from a viewpoint of the stabilization of the attitude, the dummy electrodes 18 are preferably located near both the opposed side surfaces 44 of the ceramic multilayer structure 10.

### Third Embodiment

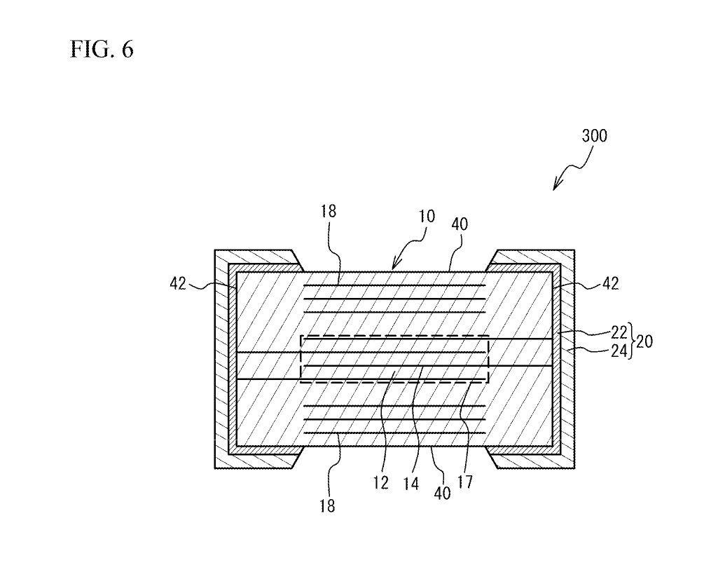

FIG. 6 is a cross-sectional view of a multilayer ceramic capacitor 300 in accordance with a third embodiment. FIG. 6 is a cross-sectional view corresponding to the cross-section taken along line A-A in FIG. 1A. As illustrated in FIG. 6, in the multilayer ceramic capacitor 300 of the third embodiment, the dummy electrodes 18 are located in regions that are located inside the ceramic multilayer structure 10, are other than the region 17, are located away from the pair of the end surfaces 42 of the ceramic multilayer structure 10, and are located between the principal surfaces 40 of the ceramic multilayer structure 10 and a plurality of the internal electrode layers 14. That is, the dummy electrodes 18 are not exposed to the pair of the end surfaces 42 of the ceramic multilayer structure 10. Other structures are the same as those of the first embodiment, and the description thereof is thus omitted.

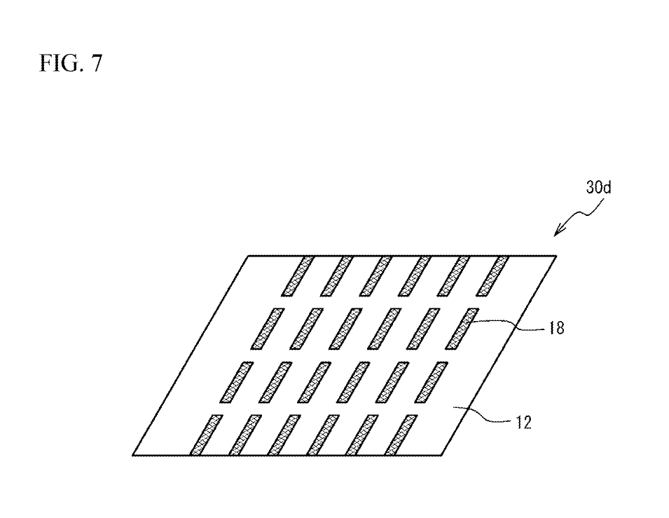

The multilayer ceramic capacitor 300 of the third embodiment can be manufactured by the same method as that of the first embodiment except that a sheet on which the dummy electrodes 18 are printed differs from the sheet of the first embodiment. FIG. 7 is a perspective view of a sheet 30d on which the dummy electrodes 18 are printed. The manufacturing method of the multilayer ceramic capacitor 300 of the third embodiment differs from that of the first embodiment in that a predetermined number (for example, 10 to 40) of the sheets 30d are stacked, a predetermined number (for example, 4 to 50) of the sheets 30a illustrated in FIG. 2A are then stacked on the top of the stacked sheets 30d so as to be alternately displaced from each other, and a predetermined number (for example, 10 to 40) of the sheets 30d are then stacked on the top of the stacked sheets 30a.

In the third embodiment, the dummy electrodes 18 are located away from the pair of the end surfaces 42 of the ceramic multilayer structure 10 and are located between the principal surfaces 40 of the ceramic multilayer structure 10 and a plurality of the internal electrode layers 14. Even in this case, the formation of capacitance by the dummy electrode 18 and the internal electrode layer 14 is inhibited. Therefore, the effect on high-frequency characteristics can be reduced and the attitude of the multilayer ceramic capacitor 300 can be stabilized. In addition, compared to the first embodiment, the dummy electrode 18 can be increased in size. Therefore, the control of the multilayer ceramic capacitor 300 with a magnet becomes easy.

The third embodiment has described an exemplary case where the dummy electrodes 18 are located near both the opposed principal surfaces 40 of the ceramic multilayer structure 10, but the dummy electrodes 18 may be only located near one of the principal surfaces 40 of the ceramic multilayer structure 10. However, from a viewpoint of the stabilization of the attitude, the dummy electrodes 18 are preferably located near both the opposed principal surfaces 40 of the ceramic multilayer structure 10.

### Fourth Embodiment

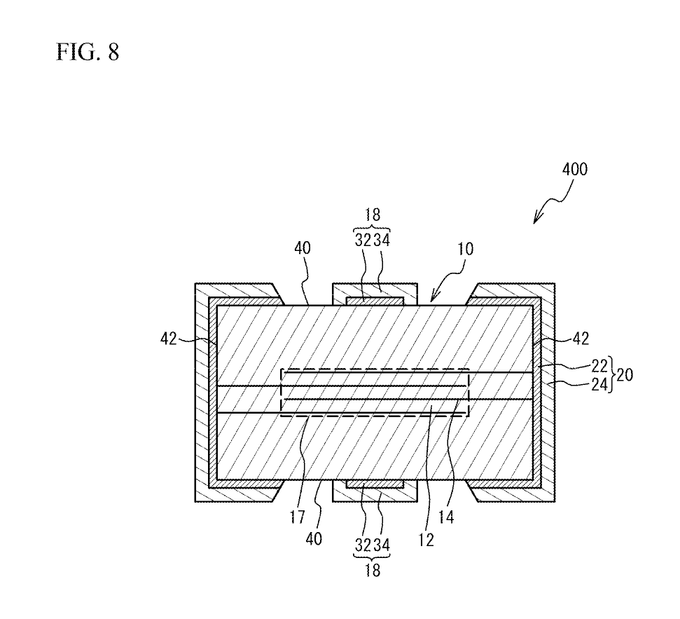

FIG. 8 is a cross-sectional view of a multilayer ceramic capacitor 400 in accordance with a fourth embodiment. FIG. 8 is a cross-sectional view corresponding to the cross-section taken along line A-A in FIG. 1A. As illustrated in FIG. 8, in the ceramic capacitor 400 of the fourth embodiment, the dummy electrodes 18 are fixedly located not inside the ceramic multilayer structure 10 but on the principal surfaces 40 among the surfaces of the ceramic multilayer structure 10. That is, the dummy electrodes 18 are located in regions other than the region 17. The dummy electrode 18 includes a base electrode 32 that is in contact with the ceramic multilayer structure 10 and a plating film 34 that is in contact with the base electrode 32 and covers the base electrode 32. The base electrode 32 and the plating film 34 are mainly composed of iron-group transition metal. Other structures are the same as those of the first embodiment, and the description thereof is thus omitted.

The ceramic capacitor 400 of the fourth embodiment can be manufactured as follows. Initially, the sheets 30a of FIG. 2A are prepared, and a predetermined number (for example, 4 to 50) of the sheets 30a are stacked so as to be alternately displaced from each other. Then, dielectric sheets on which no electrodes are printed are stacked on the top and bottom of the stacked sheets 30a. The stacked sheets are pressed to be bonded together and unite, and then cut into small pieces by a cutting machine to obtain the ceramic multilayer structure 10 in which the end edges of the internal electrode layers 14 are exposed to both end surfaces in the length direction of the ceramic dielectric layers 12. A conductive paste for forming the base electrode 22 is applied to the end surfaces 42 of the obtained ceramic multilayer structure 10, and a conductive paste for forming the base electrode 32 is applied to the principal surfaces 40. A molded body is obtained through the above-described process. The conductive paste for forming the base electrode 22 may be the same as the one described in the first embodiment. The conductive paste for forming the base electrode 32 contains powder of the metal mainly constituting the base electrode 32, a binder, a solvent, and other auxiliary agents as necessary. The binder and the solvent may be the same as those contained in the conductive paste for forming the internal electrode layer 14 described above. In addition, for example, the ceramic material mainly constituting the ceramic dielectric layer 12 is distributed as a co-material into the conductive paste for forming the base electrode 32. The content of the ceramic material in the conductive paste for forming the base electrode 32 is made to be 5 weight % or less.

Then, the obtained molded body is calcined in a reducing atmosphere with, for example, H₂ of 1.5 vol %, at approximately 950° C. for about two hours. This process allows the calcination of the ceramic dielectric layers 12 and the internal electrode layers 14 and the baking of the base electrodes 22 and 32 to be simultaneously performed.

Then, the plating films 24 are formed on the base electrodes 22 by electrolytic plating, and the plating films 34 are formed on the base electrodes 32 by electrolytic plating. The multilayer ceramic capacitor 400 is obtained through the above-described processes.

In the fourth embodiment, the dummy electrodes 18 are located on the surfaces of the ceramic multilayer structure 10. Even in this case, the effect on high-frequency characteristics can be reduced and the attitude of the multilayer ceramic capacitor 400 can be stabilized. In addition, since the dummy electrode 18 can be formed large and the dummy electrode 18 is located on the surface of the ceramic multilayer structure 10, the control of the multilayer ceramic capacitor 400 with a magnet becomes easy.

The fourth embodiment has described an exemplary case where the dummy electrodes 18 are located on the principal surfaces 40 of the ceramic multilayer structure 10, but the dummy electrodes 18 may be located on the side surfaces 44 of the ceramic multilayer structure 10. It is enough for the dummy electrode 18 to be located on one of the principal surfaces 40 or one of the side surfaces 44 of the ceramic multilayer structure 10, but from a viewpoint of the stabilization of the attitude, the dummy electrodes 18 are preferably located on both the opposed principal surfaces 40 or both the opposed side surfaces 44 of the ceramic multilayer structure 10.

Although the embodiments of the present invention have been described in detail, it is to be understood that the various change, substitutions, and alterations could be made hereto without departing from the spirit and scope of the invention.

What is claimed is:

1. A multilayer ceramic capacitor comprising:
a ceramic multilayer structure in which a ceramic dielectric layer and an internal electrode layer mainly composed of transition metal other than iron-group transition metal are alternately stacked, and a plurality of the stacked internal electrode layers are alternately exposed to a pair of end surfaces of the ceramic multilayer structure;
a pair of external electrodes that are coupled to the internal electrode layer in the pair of end surfaces and are mainly composed of transition metal other than iron-group transition metal; and
a conductor that is fixed to the ceramic multilayer structure, is located in a region other than a region in which the plurality of the internal electrode layers face each other, and is mainly composed of iron-group transition metal.

2. The multilayer ceramic capacitor according to claim 1, wherein
the conductor is located inside the ceramic multilayer structure.

3. The multilayer ceramic capacitor according to claim 2, wherein
the ceramic multilayer structure has a rectangular parallelepiped shape, and
the conductor is located closer to at least one of principal surfaces of the ceramic multilayer structure than the plurality of the internal electrode layers, and is located in a region that is located between an internal electrode layer exposed to one of the pair of end surfaces among the plurality of the internal electrode layers and another one of the pair of end surfaces, extends in a stacking direction, and is located inside the ceramic multilayer structure, the principal surfaces facing each other in the stacking direction.

4. The multilayer ceramic capacitor according to claim 2, wherein
the ceramic multilayer structure has a rectangular parallelepiped shape, and
the conductor is located in a region that is located between at least one of side surfaces of the ceramic multilayer structure and the plurality of the internal electrode layers, extends in a stacking direction, and is located inside the ceramic multilayer structure, the side surfaces intersecting with the pair of end surfaces and principal surfaces of the ceramic multilayer structure, the principal surfaces facing each other in the stacking direction.

5. The multilayer ceramic capacitor according to claim 2, wherein
the ceramic multilayer structure has a rectangular parallelepiped shape, and
the conductor is located away from the pair of end surfaces of the ceramic multilayer structure, and is located between at least one of principal surfaces of the ceramic multilayer structure and the plurality of the internal electrode layers, the principal surfaces facing each other in a stacking direction.

6. The multilayer ceramic capacitor according to claim 1, wherein
the conductor is located on a surface of the ceramic multilayer structure.

7. The multilayer ceramic capacitor according to claim 1, wherein
the ceramic dielectric layer is made of CaZrO₃,
the internal electrode layer and the external electrode are mainly composed of Cu, and
the conductor is mainly composed of Ni.
